(19) United States
(12) Patent Application Publication
(10) Pub. No.: US 2015/0157163 A1
(43) Pub. Date: Jun. 11, 2015

(54) BREWING DEVICE

(71) Applicant: TSUNG-YING LIN, Taichung City (TW)

(72) Inventor: TSUNG-YING LIN, Taichung City (TW)

(21) Appl. No.: 14/496,866

(22) Filed: Sep. 25, 2014

(30) Foreign Application Priority Data
Dec. 6, 2013 (TW) 102144794

(51) Int. Cl. A47J 31/10

(52) U.S. Cl. CPC A47J 31/10

(57) ABSTRACT

A brewing device is provided, including a main container and a brewing container. The brewing container can be arranged in the main container in each of two angles for brewing, infusion or filtering. The brewing container can be first used to steep coffee powder or tea leaves for a while in one of the two angles, and then the brewing container is taken out from the main container to drip in the other angle to control a concentration of coffee or tea brewed.

### BACKGROUND OF THE INVENTION

1. Field of the Invention

The present invention relates to a brewing device for brewing coffee or tea.

2. Description of the Prior Art

As the living standard and income rise, the number of people drinking coffee is increasing, and coffee chains can be seen everywhere. So far, there are various ways of brewing coffee, and different ways of brewing result in different flavors and tastes. Usually, coffee powder is put in a filter paper on a brewing device, and hot water is poured in to flow through coffee powder and dissolve coffee ingredients. Finally, when liquid flows through the filter paper, it becomes coffee ready to serve. The brewing device is usually saddled on a top of a container to let coffee liquid to flow through the filter paper and into the container. However, using this kind of brewing method makes a user unable to control the time that the liquid stays in the filter paper, so a concentration of brewed coffee is influenced by factors like flow speed and temperature.

The present invention is, therefore, arisen to obviate or at least mitigate the above-mentioned disadvantages.

### SUMMARY OF THE INVENTION

The main object of the present invention is to provide a brewing device for a user to control a concentration of brewed coffee.

To achieve the above and other objects, the brewing device of the present invention includes a main container and a brewing container.

The main container is surroundingly formed with a first brewing chamber and has a first opening. The brewing container is surroundingly formed with a second brewing chamber, and a second opening and at least one dripping hole are disposed at two ends of the brewing container respectively. The main container and the brewing container have a first restriction structure and a second restriction structure respectively, and the brewing container can be arranged in the first brewing chamber of the main container in one of at least two angles. When the brewing container is arranged in the main container in a first angle, the dripping hole of the brewing container contacts an interior surface of the first brewing chamber of the main container and is closed. When the brewing container is arranged in the main container in a second angle, the first restriction structure and the second restriction structure abut against and are stuck with each other to allow the brewing container to suspend inside the main container and keep the dripping hole open.

Thereby, a user can arrange the brewing container in the first or second angle, and s/he can brew, steep or filter coffee. In addition, after the user steeps coffee powder for a while in the first angle, the user can take the brewing container out and arrange it in the second angle to let coffee liquid drip. With the brewing device, it is convenient to control a concentration of brewed coffee.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is a breakdown drawing of the present invention; and

FIGS. 3-6 are drawings showing the present invention in use.

### DETAILED DESCRIPTION OF THE PREFERRED EMBODIMENTS

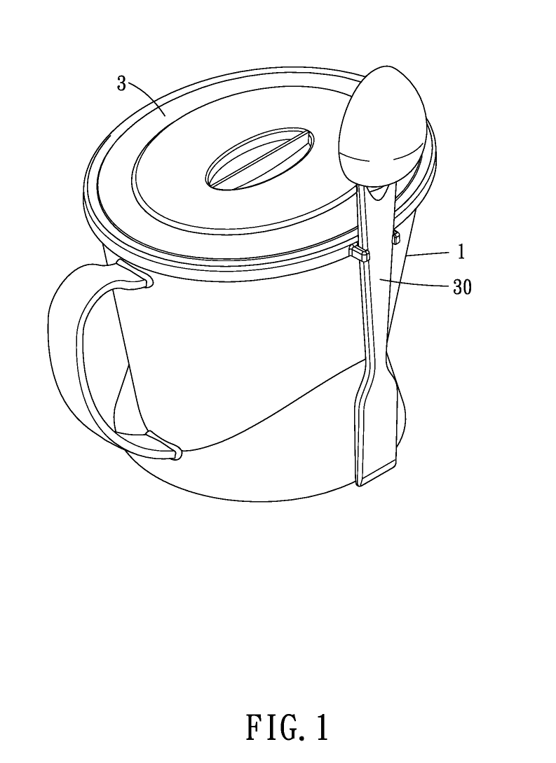

Please refer to FIG. 1 to FIG. 3 for a brewing device of the present invention, including a main container 1 and a brewing container 2.

A cross-section of the main container 1 is substantially oval. The main container 1 is surroundingly formed with a first brewing chamber 11 and has a first opening. An interior surface of the first brewing chamber 11 of the main container 1 has a first restriction structure, and the first restriction structure includes two protruding blocks 13. The two protruding blocks 13 are disposed correspondingly on two lateral sides of the first brewing chamber 11 respectively.

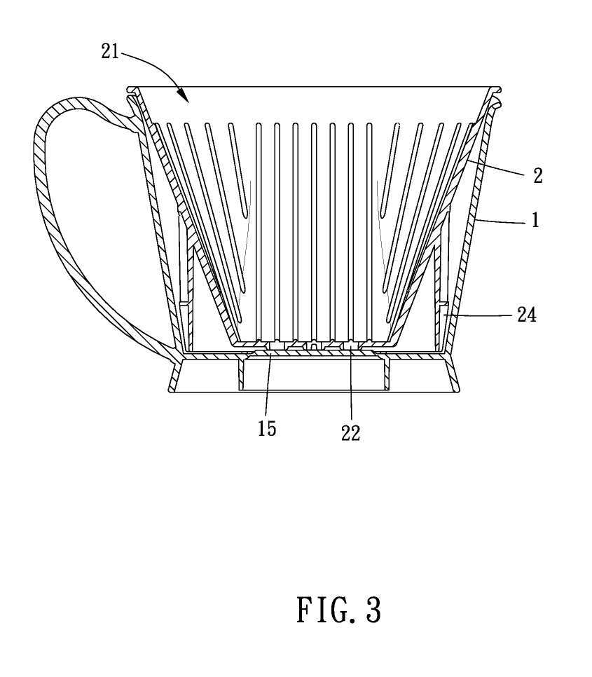

A cross-section of the brewing container 2 is substantially oval. A shape of the cross-section of the brewing container 2 corresponds to that of the main container 1, so the brewing container 2 can overlap with the main container 1 and be arranged in the first brewing chamber 11 of the main container 1. The brewing container 2 is surroundingly formed with a second brewing chamber 21, and a second opening and a plurality of dripping holes 22 are disposed at a top end and a bottom end of the brewing container 2 respectively. The second brewing chamber 21 is provided for putting a filter paper therein. A diameter of the brewing container 2 tapers from the second opening to the dripping holes 22. An end of the brewing container 2 near the dripping holes 22 is formed with an annular base 24. The base 24 surrounds the dripping holes 22, and a position of the dripping holes 22 is higher than a position of a bottom portion of the base 24 (as viewed from the angle of FIG. 3). That is, the base 24 is in the lowest position of the brewing container 2. The brewing container 2 is placed on the interior surface of the first brewing chamber 11 of the main container 1 via the base 24, and a gap is formed between the dripping holes 22 and the interior surface of the first brewing chamber 11. The brewing container 2 is formed with a second restriction structure which includes two protruding slots 26. The two protruding slots 26 are disposed correspondingly on two lateral sides of an outer circumferential face of the base 24.

In use, the brewing container 2 can be arranged in the first brewing chamber 11 of the main container 1 in one of at least two angles. When the brewing container 2 is arranged in the main container 1 in a first angle, the major axial directions of the brewing container 2 and the main container 1 are parallel to each other, the brewing container 2 can be arranged in the first brewing chamber 11 completely, a top verge of the brewing container 2 abuts against a top verge of the main container 1, and the dripping holes 22 of the brewing container 2 contact the interior surface of the first brewing chamber 11 of the main container 1 and are closed (the bottom portion of the interior surface of the main container 1 is formed with a protruding portion 15 whose structure corresponds to that of the dripping holes 22, and the dripping holes 22 abut against the protruding portion 15 and are closed). When the brewing container 2 is arranged in the main container 1 in a second angle, the major axial directions of the brewing container 2 and the main container 1 are perpendicular to each other, and the first restriction structure and the second restriction structure abut against and are stuck with each other to allow the brewing container 2 to suspend inside the main container 1 and keep the dripping holes open. More specifically, when the brewing container 2 is arranged in the main container 1 in the second angle, the protruding block 13 is stuck into the concave slot 26; therefore, the brewing container 2 can only be partially arranged in the main container 1 to keep the dripping holes 22 suspending and open.

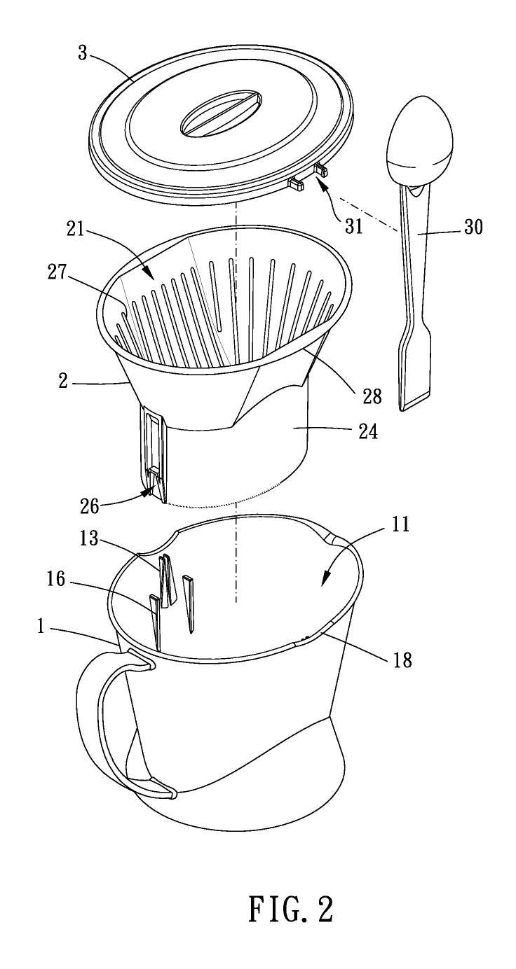

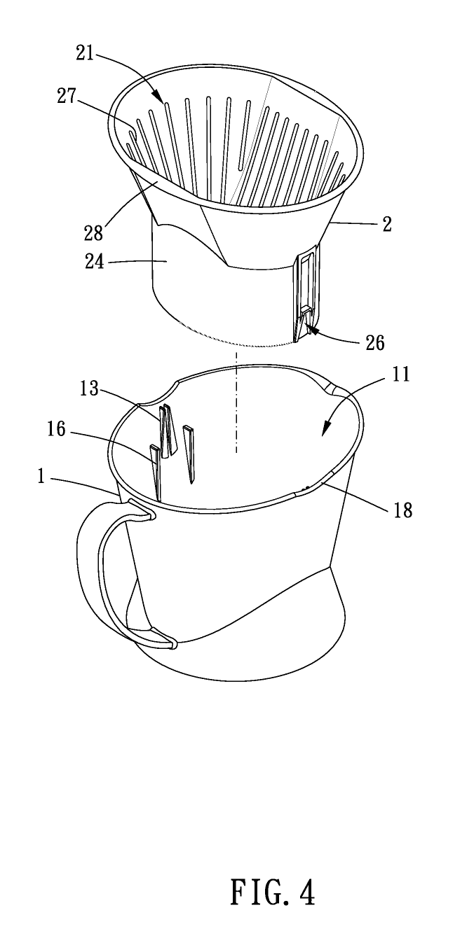

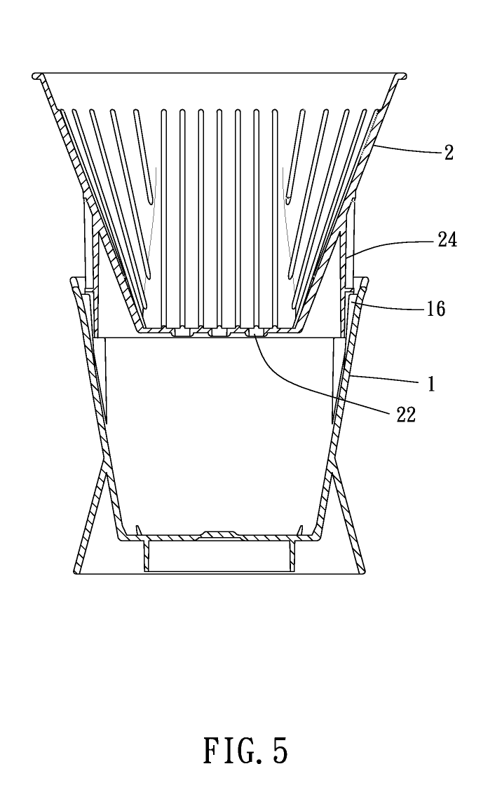

Therefore, in actual brewing process (please refer to FIGS. 2 and 3), the user can arrange the brewing container 2 in the main container 1 in the first angle, spread the filter paper on the second brewing chamber 21 of the brewing container 2, put coffee powder in the filter paper, and pour a proper amount of hot water into the second brewing chamber 21 to brew coffee. The dripping holes 22 contact and abut against the main container 1 and are closed; therefore, a liquid in the second brewing chamber 21 cannot flow from the dripping holes 22 into the main container 1, and coffee powder is steeped in hot water. After steeping (please refer to FIGS. 4 and 5), the user can lift the brewing container 2 upward and arrange it in the main container 1 in the second angle to make the brewing container 2 suspend and allow the liquid in the second brewing chamber 21 to flow through the filter paper into the first brewing chamber 11 of the main container 1 through the dripping holes 22. The liquid in the first brewing chamber 11 is now ready to drink.

One of the characteristics of the present invention is that after brewing coffee, the brewing container 2 can be taken out and suspended in the second angle. Then, coffee liquid flows through the filter paper into the main container 1, and after a while, the user can enjoy a cup of coffee. The brewing device of the present invention is easy to use.

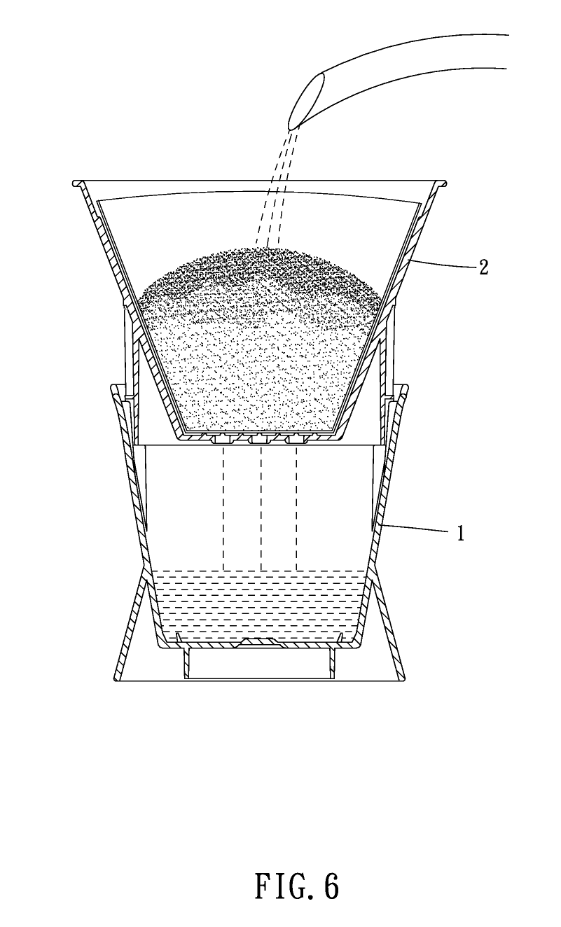

Furthermore, the user can steep coffee powder in hot water in the first angle for a predetermined time, and then, s/he can take out the brewing container 2 and arrange it in the second angle to allow the coffee liquid to drip. The concentration of coffee can be controlled through the time of steeping. In addition, in other ways of brewing, the user can arrange the brewing container 2 in the second angle and pour hot water in it directly (as shown in FIG. 6). The present invention can be used in many ways.

In addition, when hot water is poured into the brewing container 2, liquid can be prevented from spilling out because the brewing container 2 is surrounded by the main container 1. Even if liquid flows out from the dripping holes 22 of the brewing container 2, liquid will flow into the main container 1 directly. The present invention is safe to use, and it can prevent problems like burn or spilling.

It is noted that in this embodiment, the interior surface of the first brewing chamber 11 of the main container 1 is formed with a plurality of supporting ribs 16. Each supporting rib 16 is disposed near the protruding block 13. When the brewing container 2 is arranged in the main container 1 in the second angle, the concave slot 26 abuts against and is stuck with the protruding block 13, and the base 24 of the brewing container 2 abuts against the supporting rib 16. The stability of the brewing container 2 is increased through multi-point contact.

In addition, the interior surface of the second brewing chamber 21 of the brewing container 2 is formed with a plurality of protruding ribs 27. When the filter paper is spread in the second brewing chamber 21 of the brewing container 2, the filter paper contacts the protruding ribs 27; therefore, there is a distance between the filter paper and the interior surface of the second brewing chamber 21 to let air flow and make liquid drip smoothly. What's more, the used filter paper can be prevented from sticking on the interior surface of the second brewing chamber 21, and it is convenient for the user to clean up.

Furthermore, a verge of the second opening of the brewing container 2 has a flange 28 extending outward, and two corresponding lateral sides of a verge of the first opening of the main container 1 have a concavity 18 respectively (the concavities 18 are disposed on the two sides widthwise). Thereby, when the brewing container 2 is arranged in the main container 1 in the first angle, the flange 28 of the brewing container 2 abuts against the verge of the first opening of the main container 1. A gap is formed between the flange 28 and the concavity 18 for the user to grasp the flange 28 with fingers and take out the brewing container 2 from the main container 1.

The brewing device of the present invention further includes a lid 3. The lid 3 can cover the first opening of the main container 1 and has a nipping opening 31 for fastening a spoon 30. A surface of the lid 3 corresponds to a bottom structure (the base 24) of the brewing container 2, and the brewing container 2 can be placed on the and restricted by the lid 3 (the lid 3 and the brewing container 2 have concave-convex structures corresponding to each other). That is, the lid 3 serves as a pad, and the brewing container 2 can be placed on the lid 3 after being taken out from the main container 1 or being used.

Although particular embodiments of the invention have been described in detail for purpose of illustration, various modifications and enhancements may be made without departing from the spirit and scope of the invention. Accordingly, the invention is not to be limited except as by the appended claims.

What is claimed is:

1. A brewing device, including:
a main container, surroundingly formed with a first brewing chamber and having a first opening;
a brewing container, surroundingly formed with a second brewing chamber, and a second opening and at least one dripping hole disposed at two ends of the brewing container;
wherein the main container and the brewing container have a first restriction structure and a second restriction structure respectively; the brewing container is arrangeable in the first brewing chamber of the main container in one of at least two angles; when the brewing container is arranged in the main container in a first angle, the dripping hole of the brewing container contacts an interior surface of the first brewing chamber of the main container and is closed; when the brewing container is arranged in the main container in a second angle, the first restriction structure and the second restriction structure abut against and are stuck with each other to allow the brewing container to suspend inside the main container and keep the dripping hole open.

2. The brewing device of claim 1, wherein the first restriction structure includes a protruding block, the second restriction structure includes a concave slot, when the brewing container is arranged in the main container in the second angle, the protruding block is stuck in the concave slot.

3. The brewing device of claim 1, wherein the interior surface of the first brewing chamber of the main container has at least one supporting rib, when the brewing container is arranged in the main container in the second angle, the brewing container abuts against the supporting rib.

4. The brewing device of claim 1, wherein an interior surface of the second brewing chamber of the brewing container has a plurality of protruding ribs.

5. The brewing device of claim 1, wherein a verge of the second opening of the brewing container is formed with a flange extending outward, a verge of the first opening of the main container has a concavity, when the brewing container is arranged in the main container in the first angle, the flange of the brewing container abuts against the verge of the first opening of the main container, and a gap is formed between the flange and the concavity.

6. The brewing device of claim 1, wherein an end of the brewing container near the dripping hole has an annular base, the base surrounds the dripping hole, and a position of the dripping hole is higher than a position of a bottom portion of the base.

7. The brewing device of claim 1, wherein a cross-section of the brewing container is substantially oval, and a diameter of the brewing container tapers from the first opening to the dripping hole.

8. The brewing device of claim 1, wherein cross-sections of the brewing container and the main container are substantially oval, when the brewing container is arranged in the main container in the first angle, the brewing container and the main container are parallel to each other in a major axial direction, and when the brewing container is arranged in the main container in the second angle, the major axial directions of the brewing container and the main container are perpendicular to each other.

9. The brewing device of claim 1, further including a lid, wherein the lid is coverable on the first opening of the main container, and a surface of the lid corresponds to a structure of a bottom portion of the brewing container to allow the brewing container to be placed on and restricted by the lid.

10. The brewing device of claim 1, further including, wherein the lid is coverable on the first opening of the main container, and the lid is formed with a nipping opening for fastening a spoon.
